(19) United States
(12) Patent Application Publication
(10) Pub. No.: US 2026/0231308 A1
(43) Pub. Date: Aug. 6, 2026

(54) VEHICLE LIGHTING DEVICE

(71) Applicant: TOYOTA JIDOSHA KABUSHIKI KAISHA, Toyota-shi (JP)

(72) Inventor: Takatsugu NAGATA, Toyota-shi (JP)

(73) Assignee: TOYOTA JIDOSHA KABUSHIKI KAISHA, Toyota-shi (JP)

(21) Appl. No.: 19/405,644

(22) Filed: Dec. 2, 2025

(30) Foreign Application Priority Data
Jan. 31, 2025 (JP) 2025-015354

(51) Int. Cl. H05B 45/59; B60Q 3/252; B60Q 3/82; H05B 47/16

(52) U.S. Cl. CPC H05B 45/59; B60Q 3/252; B60Q 3/82; H05B 47/16

(57) ABSTRACT

The vehicle lighting device includes a vanity lamp implemented using a light-emitting diode, a switch for turning on or off the vanity lamp, and a controller that, in conjunction with the vanity lamp, constitutes a first closed circuit and that, in conjunction with the switch, constitutes a second closed circuit. The controller of the vehicle lighting device performs control such that a value of a current flowing through the first closed circuit and a value of a current flowing through the second closed circuit are different from each other.

### CROSS-REFERENCE TO RELATED APPLICATION

This application claims priority to Japanese Patent Application No. 2025-015354 filed on January 31, 2025. The disclosure of the above-identified application, including the specification, drawings, and claims, is incorporated by reference herein in its entirety.

### BACKGROUND

### 1. Technical Field

The present disclosure relates to a vehicle lighting device.

### 2. Description of Related Art

Japanese Unexamined Patent Application Publication No. 2010-208625 (JP 2010-208625 A) discloses a lighting circuit that drives light-emitting diodes in a vanity mirror without voltage level fluctuations.

### SUMMARY

Meanwhile, as disclosed in JP 2010-208625 A, in a case where a vanity lamp in a vehicle cabin is implemented using light-emitting diodes (LEDs), reducing a value of a current flowing through the vanity lamp is necessary. Therefore, in a case where the vanity lamp itself and a switch for turning on or off the vanity lamp are connected in series, the same current as the current flowing through the vanity lamp also flows through the switch, so that the current flowing through the switch is also reduced.

An oxide film, impurities, or the like may develop on the switch due to aging or the like. However, in a case where the current flowing through the switch is small, it is not possible to remove (or break down) the oxide film, impurities, or the like with the current, and as a result, a poor contact of the switch may occur. Therefore, in the case where the vanity lamp implemented using the light-emitting diodes and the switch are connected in series, there is a problem that blinking of the vanity lamp is likely to occur.

The present disclosure has been made in view of the points described above, and an object of the present disclosure is to suppress occurrence of blinking of a vanity lamp implemented using a light-emitting diode.

A vehicle lighting device according to a first aspect of the present disclosure includes: a vanity lamp that is implemented using a light-emitting diode; a switch configured to turn on or off the vanity lamp; and a controller that, in conjunction with the vanity lamp, constitutes a first closed circuit and that, in conjunction with the switch, constitutes a second closed circuit. The controller is configured to perform control such that a value of a current flowing through the first closed circuit and a value of a current flowing through the second closed circuit are different from each other. With the vehicle lighting device according to the first aspect of the present disclosure, it is possible to suppress the occurrence of blinking of the vanity lamp implemented using the light-emitting diode.

A vehicle lighting device according to a second aspect of the present disclosure is the vehicle lighting device according to the first aspect. The controller is configured to perform control such that the value of the current flowing through the second closed circuit is larger than the value of the current flowing through the first closed circuit. With the vehicle lighting device according to the second aspect of the present disclosure, it is possible to suppress the occurrence of blinking of the vanity lamp by removing an oxide film, impurities, or the like that may develop on the switch with a large current, thereby suppressing the occurrence of poor contact of the switch.

A vehicle lighting device according to a third aspect of the present disclosure is the vehicle lighting device according to the first or second aspect. The controller is configured to perform control such that, in a case where a signal indicating switching between turning on and turning off the vanity lamp is repeatedly issued in a predetermined time section, the signal indicating the switching is removed. With the vehicle lighting device according to the third aspect of the present disclosure, it is possible to suppress the blinking of the vanity lamp caused by causes other than the poor contact of the switch due to the oxide film, impurities, or the like.

A vehicle lighting device according to a fourth aspect of the present disclosure is the vehicle lighting device according to the first to third aspects. The controller is configured to perform control such that, in a case where an off signal is issued to the vanity lamp, the vanity lamp is turned off after a preset time has elapsed from an output of the off signal. With the vehicle lighting device according to the fourth aspect of the present disclosure, it is possible to suppress the blinking of the vanity lamp caused by causes other than the poor contact of the switch due to the oxide film, impurities, or the like.

A vehicle lighting device according to a fifth aspect of the present disclosure is the vehicle lighting device according to the first to fourth aspects. The controller is a microcontroller incorporated in an overhead console in a vehicle. With the vehicle lighting device according to the fifth aspect of the present disclosure, it is possible to control the vanity lamp and the switch from the overhead console located in the vicinity of the vanity lamp and the switch, so that it is possible to reduce the amount of wiring needed.

According to the present disclosure, an effect is obtained that the occurrence of blinking of the vanity lamp implemented using the light-emitting diode can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a diagram showing a configuration example of a vehicle lighting device according to an embodiment;

FIG. 1B is a diagram showing a configuration example of the vehicle lighting device according to the embodiment;

FIG. 2 is a diagram for describing filtering control;

FIG. 3 is a diagram for describing delay control;

FIG. 4 is a diagram showing a configuration example of a computer of a controller according to the embodiment;

FIG. 5 is an example of processing performed by the vehicle lighting device; and

FIG. 6 is a diagram showing a configuration example of a vehicle lighting device in the related art.

### DETAILED DESCRIPTION OF EMBODIMENTS

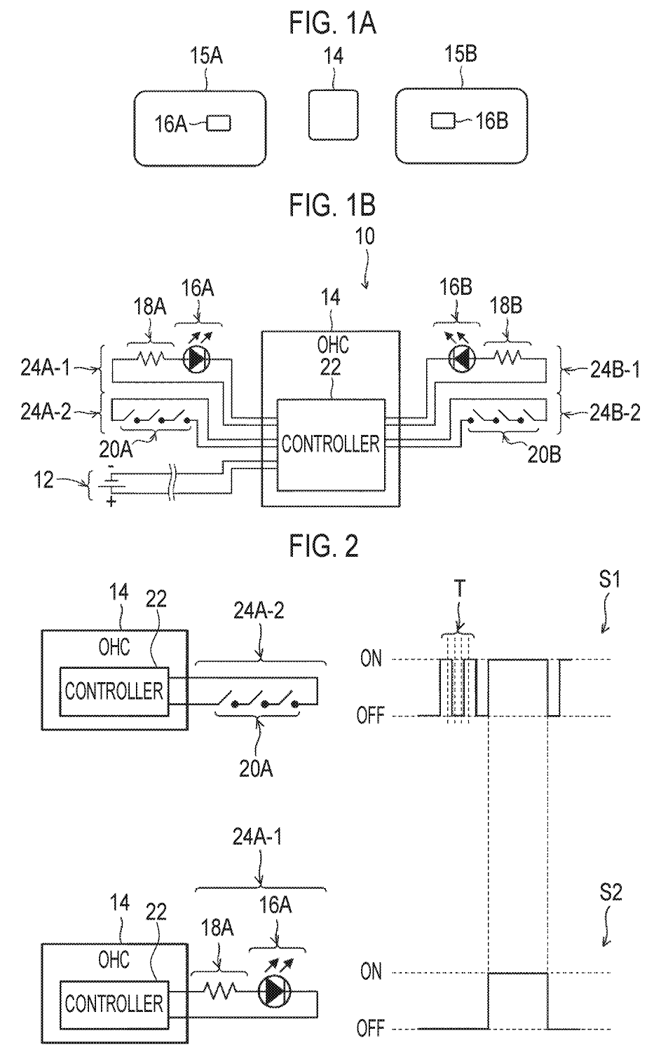

FIGS. 1A and 1B are diagrams showing a configuration example of a vehicle lighting device 10 according to the present embodiment.

FIG. 1A is a diagram showing an overhead console (hereinafter, simply referred to as "OHC") 14 installed in the vicinity above a driver's seat and a front passenger's seat in a vehicle cabin, and visors 15A, 15B. The OHC 14 shown in FIG. 1A is installed, for example, on a ceiling portion between the driver's seat and the front passenger's seat, and has a function of controlling lighting in the vehicle cabin. The visor 15A is provided, for example, on a driver's seat side, and the visor 15B is provided, for example, on a front passenger's seat side. Vanity lamps 16A, 16B implemented using light-emitting diode are installed on the visors 15A, 15B themselves or at locations on back sides of the visors 15A, 15B. The vanity lamps 16A, 16B are used in a case where vanity mirrors (not shown) installed on the visors 15A, 15B are used.

In addition, FIG. 1B is a diagram showing a circuit configuration example of the vehicle lighting device 10 according to the present embodiment. The circuit configuration of the vehicle lighting device 10 according to the present embodiment will be described below.

FIG. 6 is a diagram showing a configuration example of a vehicle lighting device 10X in the related art. As shown in FIG. 6, the vehicle lighting device 10X in the related art includes a power supply 12, an OHC 14X, the vanity lamps 16A, 16B, resistance elements 18A, 18B, and switches 20A, 20B.

The switches 20A, 20B are turned on or off by the pivoting of the visors 15A, 15B. For example, in a case where the visors 15A, 15B are pivoted from a folded state to an unfolded state, the switches 20A, 20B are turned on, and the vanity lamps 16A, 16B are turned on. On the other hand, in a case where the visors 15A, 15B are pivoted from the unfolded state to the folded state, the switches 20A, 20B are turned off, and the vanity lamps 16A, 16B are turned off. Some of elements or some of wiring lines in the electric circuit shown in FIG. 6 can be incorporated into an electric circuit inside the OHC 14X.

As described above, in the vehicle lighting device 10X in the related art as shown in FIG. 6, the vanity lamp 16A and the switch 20A are connected in series. In addition, in the vehicle lighting device 10X, the vanity lamp 16B and the switch 20B are connected in series. Therefore, currents flowing through the switches 20A, 20B are small currents for the vanity lamps 16A. 16B. However, an oxide film, impurities, or the like may develop on the switches 20A, 20B due to aging or the like. In such a case, the oxide film, the impurities, or the like developed on the switches 20A, 20B portions cannot be removed with the small current for the vanity lamp. Therefore, the poor contact of the switch due to the oxide film, the impurities, or the like occurs, and blinking (or chattering) of the vanity lamp is likely to occur.

Therefore, in the present embodiment, the vanity lamps 16A, 16B and the switches 20A, 20B are each provided in different closed circuits, so that the current flowing through the vanity lamps 16A, 16B and the current flowing through the switches 20A, 20B can be made different from each other.

FIG. 1B is a diagram showing a circuit configuration example of the vehicle lighting device 10 according to the present embodiment. As shown in FIG. 1B, the vehicle lighting device 10 includes the power supply 12, the OHC 14, the vanity lamps 16A, 16B, the resistance elements 18A, 18B, and the switches 20A, 20B.

The power supply 12 supplies power to the vanity lamps 16A, 16B via a controller 22 provided in the OHC 14.

The OHC 14 includes the controller 22. The controller 22 is, for example, a microcontroller or the like incorporated in the OHC 14 in the vehicle.

The vanity lamps 16A, 16B are implemented using light-emitting diode. The vanity lamps 16A, 16B are turned on or off in response to the on/off operation of the switches 20A, 20B described below.

The resistance elements 18A, 18B are installed at locations as shown in FIG. 1B and adjust the current flowing through the circuit.

The switch 20A turns on or off the vanity lamp 16A. In addition, the switch 20B turns on or off the vanity lamp 16B. For example, the switches 20A, 20B turn on or off the vanity lamps 16A, 16B in response to the pivoting of the visors 15A, 15B.

As shown in FIG. 1B, a closed circuit 24A-1 is provided between the controller 22 and the vanity lamp 16A. In addition, a closed circuit 24A-2 is provided between the controller 22 and the switch 20A. In addition, a closed circuit 24B-1 is provided between the controller 22 and the vanity lamp 16B. In addition, a closed circuit 24B-2 is between the controller 22 and the switch 20B. The closed circuits 24A-1, 24B-1 are examples of a first closed circuit of the present disclosure. The closed circuits 24A-2, 24B-2 are examples of a second closed circuit of the present disclosure.

Therefore, the controller 22 can make a value of the current flowing through the closed circuit 24A-1 different from a value of the current flowing through the closed circuit 24A-2. In addition, the controller 22 can make a value of the current flowing through the closed circuit 24B-1 different from a value of the current flowing through the closed circuit 24B-2.

The controller 22 performs control such that the value of the current flowing through the closed circuit 24A-2 is larger than the value of the current flowing through the closed circuit 24A-1. In addition, the controller 22 performs control such that the value of the current flowing through the closed circuit 24B-2 is larger than the value of the current flowing through the closed circuit 24B-1. As a result, the current flowing through the switches 20A, 20B can be made larger than the current flowing through the vanity lamps 16A, 16B, and the oxide film, the impurities, or the like can be removed (or broken down) with the large current. As a result, the occurrence of poor contact of the switches 20A, 20B is suppressed, and the occurrence of blinking of the vanity lamps 16A, 16B can be suppressed.

Performing control such that the value of the current flowing through the closed circuit 24A-2 is larger than the value of the current flowing through the closed circuit 24A-1 is also equivalent to performing control such that the value of the current flowing through the closed circuit 24A-1 is smaller than the value of the current flowing through the closed circuit 24A-2. In addition, similarly, performing control such that the value of the current flowing through the closed circuit 24B-2 is larger than the value of the current flowing through the closed circuit 24B-1 is also equivalent to performing control such that the value of the current flowing through the closed circuit 24B-1 is smaller than the value of the current flowing through the closed circuit 24B-2. Therefore, the controller 22 performs control such that a small current for the light-emitting diode flows through the closed circuits 24A-1, 24B-1 including the vanity lamps 16A, 16B.

The controller 22 further performs filtering control and delay control described below. By performing the filtering control and the delay control described below, the occurrence of blinking of the vanity lamps 16A, 16B that could not be resolved simply by increasing the current flowing through the switches 20A, 20B can also be suppressed.

### Filtering Control

The controller 22 performs control such that a signal indicating switching is removed in a case where the signal indicating switching between turning on and turning off the vanity lamps 16A, 16B is repeatedly issued in a predetermined time section.

FIG. 2 is a diagram for describing the filtering control. For example, as shown in an upper part of FIG. 2, a case is considered in which a signal S1 including repetition of the signal indicating the switching between turning on and turning off is issued from the closed circuit 24A-2 including the switch 20A. In this case, as shown in a lower part of FIG. 2, the controller 22 performs filtering to remove a repeated portion of the signal indicating the switching from the signal S1. Specifically, the controller 22 performs processing of removing the repeated portion in a case where the signal indicating the switching between turning on and turning off is repeatedly issued in a predetermined time section T. As a result, the signal S1 has a waveform shape of a signal S2. The controller 22 performs control such that the vanity lamp 16A is turned on or off based on an on/off signal such as the signal S2. As a result, the occurrence of blinking of the vanity lamp 16A can be suppressed. Specifically, it is possible to suppress the blinking of the vanity lamp 16A caused by causes other than the poor contact of the switch due to the oxide film, impurities, or the like.

### Delay Control

The controller 22 performs control such that the vanity lamps 16A, 16B is turned off after a preset time has elapsed from an output of an off signal in a case where the off signal is issued to the vanity lamps 16A, 16B.

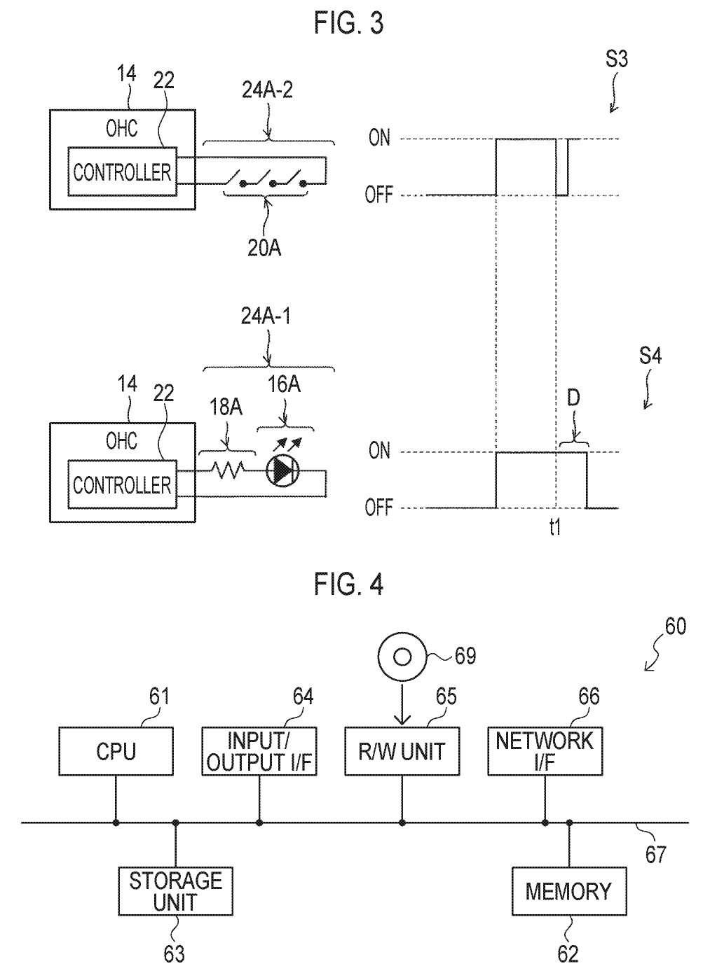

FIG. 3 is a diagram for describing delay control. For example, as shown in an upper part of FIG. 3, a case is considered in which a signal S3 is issued from the closed circuit 24A-2 including the switch 20A. In this case, as shown in a lower part of FIG. 3, the controller 22 performs control such that the vanity lamp 16A is turned off after a preset time D has elapsed from the time t1 at which the off signal of the signal S3 is output. As a result, the signal S3 has a waveform shape of a signal S4. The controller 22 performs control such that the vanity lamp 16A is turned on or off based on an on/off signal such as the signal S4. As a result, the occurrence of blinking of the vanity lamp 16A can be suppressed. Specifically, it is possible to suppress the blinking of the vanity lamp 16A caused by causes other than the poor contact of the switch due to the oxide film, impurities, or the like.

The controller 22 is implemented using, for example, a microcontroller or the like. For example, the controller 22 can be implemented using a semiconductor integrated circuit, more specifically, an application specific integrated circuit (ASIC) or the like.

In addition, the controller 22 can also be implemented using, for example, a computer 60 as shown in FIG. 4. The computer 60 that implements the controller 22 includes a central processing unit (CPU) 61, a memory 62 as a temporary storage area, and a non-volatile storage unit 63. In addition, the computer includes an input/output interface (I/F) 64 to which an input/output device or the like (not shown) is connected, and a read/write (R/W) unit 65 that controls reading and writing of data with respect to a recording medium 69. In addition, the computer includes a network I/F 66 connected to a network such as the Internet. The CPU 61 that is an example of a processor, the memory 62, the storage unit 63, the input/output I/F 64, the R/W unit 65, and the network I/F 66 are connected to each other via a bus 67.

The storage unit 63 can be implemented using a hard disk drive (HDD), a solid state drive (SSD), a flash memory, or the like. The storage unit 63 as a storage medium stores a program for functioning the computer. The CPU 61 reads out the program from the storage unit 63, loads the program into the memory 62, and sequentially executes the processes included in the program.

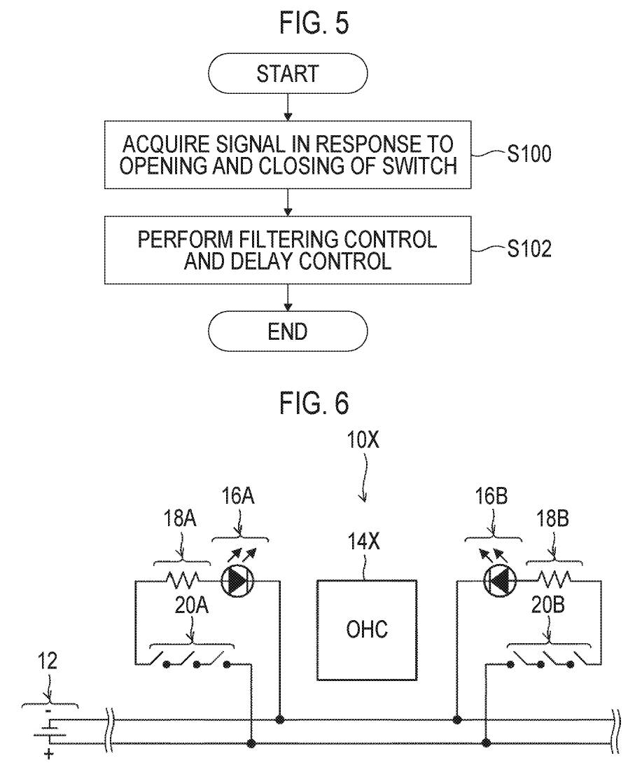

Next, an operation of the vehicle lighting device 10 according to the embodiment will be described. The vehicle lighting device 10 executes a processing routine as shown in FIG. 5.

In step S100, the controller 22 acquires a signal output from the closed circuit 24A-2 including the switch 20A and a signal output from the closed circuit 24B-2 including the switch 20B.

In step S102, the controller 22 performs the filtering control and the delay control described above based on the signals acquired in step S100.

In a case where the signal output from the closed circuit 24A-2 including the switch 20A indicates an on state, the controller 22 performs control such that the value of the current flowing through the closed circuit 24A-2 is larger than the value of the current flowing through the closed circuit 24A-1. In addition, in a case where the signal output from the closed circuit 24B-2 including the switch 20B indicates an on state, the controller 22 performs control such that the value of the current flowing through the closed circuit 24B-2 is larger than the value of the current flowing through the closed circuit 24B-1. The controller 22 performs control such that a small current for the light-emitting diode flows through the closed circuits 24A-1, 24B-1 including the vanity lamps 16A, 16B.

As described above, the vehicle lighting device 10 according to the embodiment includes: a vanity lamp that is implemented using a light-emitting diode; a switch configured to turn on or off the vanity lamp; and a controller configured to provide a first closed circuit with the vanity lamp and a second closed circuit with the switch, in which the controller is configured to perform control such that a value of a current flowing through the first closed circuit and a value of a current flowing through the second closed circuit are different from each other. As a result, it is possible to suppress the occurrence of blinking of the vanity lamp implemented using the light-emitting diode.

The processing performed by each device in the above embodiment has been described as an example of being performed by hardware, but it may also be performed as software processing by executing a program. Alternatively, processing may be performed by a combination of both the software and the hardware. In addition, the program stored in a ROM in this case may be stored in various storage media and distributed.

Further, the present disclosure is not limited to the above, and it is needless to say that the present disclosure can be variously modified within a range not departing from the gist of the present disclosure.

For example, in the embodiment described above, a case where the controller 22 performs the filtering control and the delay control has been described as an example, but these controls may not be performed.

In addition, in the embodiment described above, a case where the controller 22, which is the microcontroller, is incorporated in the OHC 14 has been described as an example, but the present disclosure is not limited thereto. For example, the controller 22 may be implemented using a processor different from the microcontroller. In addition, the controller 22 may be implemented using an electronic control unit (ECU) that is present at a location different from the OHC 14.

What is claimed is:

1. A vehicle lighting device comprising:
a vanity lamp that is implemented using a light-emitting diode;
a switch configured to turn on or off the vanity lamp; and
a controller that, in conjunction with the vanity lamp, constitutes a first closed circuit and that, in conjunction with the switch, constitutes a second closed circuit,
wherein the controller is configured to perform control such that a value of a current flowing through the first closed circuit and a value of a current flowing through the second closed circuit are different from each other.

2. The vehicle lighting device according to claim 1, wherein the controller is configured to perform control such that the value of the current flowing through the second closed circuit is larger than the value of the current flowing through the first closed circuit.

3. The vehicle lighting device according to claim 1, wherein the controller is configured to perform control such that, in a case where a signal indicating switching between turning on and turning off the vanity lamp is repeatedly issued in a predetermined time section, the signal indicating the switching is removed.

4. The vehicle lighting device according to claim 1, wherein the controller is configured to perform control such that, in a case where an off signal is issued to the vanity lamp, the vanity lamp is turned off after a preset time has elapsed from an output of the off signal.

5. The vehicle lighting device according to claim 1, wherein the controller is a microcontroller incorporated in an overhead console in a vehicle.
